(19) United States
(12) Patent Application Publication
(10) Pub. No.: US 2010/0269363 A1
(43) Pub. Date: Oct. 28, 2010

(54) WAIST BELT WITH SIZE RULER INDICIA

(76) Inventor: Shuo-Hsiu Johnny Chang, Taipei City (TW)

Correspondence Address: WPAT, PC;INTELLECTUAL PROPERTY ATTORNEYS, 7225 BEVERLY ST., ANNANDALE, VA, 22003, US

(21) Appl. No.: 12/540,117

(22) Filed: Aug. 12, 2009

Related U.S. Application Data
(60) Provisional application No. 61/172,431, filed on Apr. 24, 2009.

(51) Int. Cl. G01B 3/10

(52) U.S. Cl. 33/759

(57) ABSTRACT

A measuring device and a method for measuring exercise progress wherein a belt/measuring device with size ruler indicia for a user to measure the circumference of his/her waist, arm or thigh, and can be used to determine the progress of an exercise routine.

This application claims priority to Provisional Application No. 61/172,431, filed on Apr. 24, 2009, now pending, which is hereby incorporated by reference in its entirety.

### BACKGROUND OF THE INVENTION

The present invention generally relates to a measuring device, more specifically, a belt having size ruler indicia, and the method for measuring exercise progress.

### SUMMARY OF THE INVENTION

In one aspect of the present invention, a belt is provided with size ruler indicia so that a user can use it to measure the circumference of his/her waist.

In another aspect of the present invention, a belt is provided with size ruler indicia so that a user can use it to measure the circumference of his/her arm or thigh.

In another aspect of the present invention, a belt is provided with size ruler indicia so a user can use it to determine the progress of an exercise routine, and the present invention can be generally called as a measuring device.

Another aspect of the present invention directs to a method for measuring exercise progress with the exercise device indicated above.

These and other features, aspects and advantages of the present invention will become better understood with reference to the following drawings, description and claims.

### BRIEF DESCRIPTION OF THE DRAWINGS

FIG. 1 is a perspective view of one embodiment of the current invention.

FIG. 2 is a perspective view of another embodiment of the current invention.

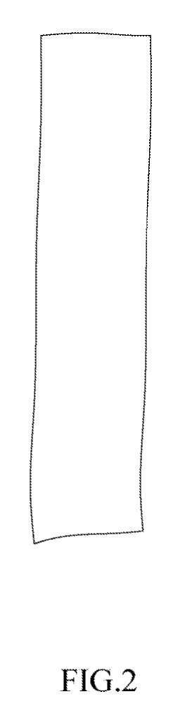

FIG. 3 is a perspective view of yet another embodiment of the current invention.

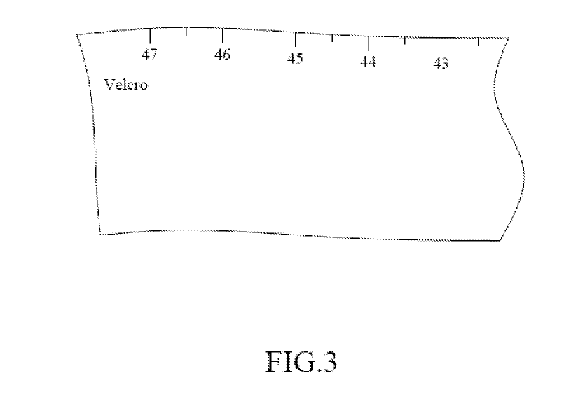

FIG. 4 is a close-up view of one embodiment of the current invention.

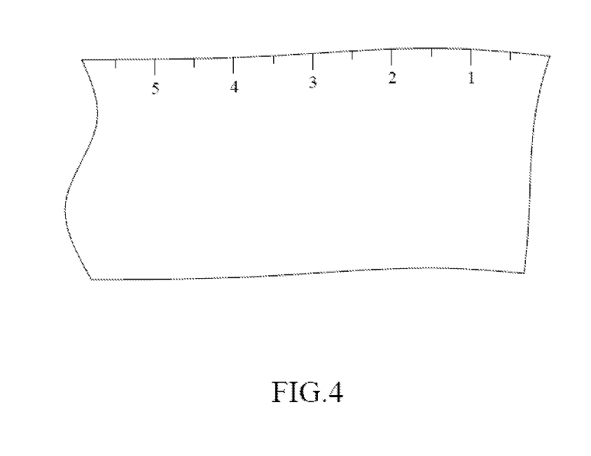

FIG. 5 is a close-up view of one embodiment of the current invention.

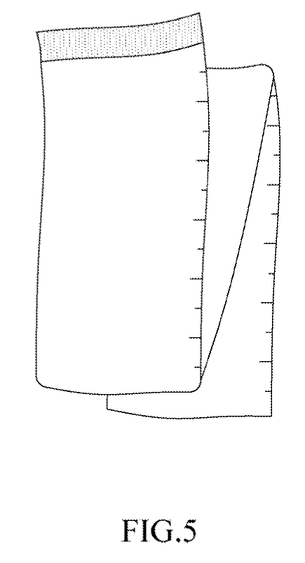

### DETAILED DESCRIPTION OF THE INVENTION

The following detailed description is of the best currently contemplated modes of carrying out exemplary embodiments of the invention. The description is not to be taken in a limiting sense, but is made merely for the purpose of illustrating the general principles of the invention.

Various inventive features are described below that can each be used independently of one another or in combination with other features.

These and other features, aspects and advantages of the present invention will become better understood with reference to the following description and drawings.

Broadly, embodiments of the present invention provide a belt having size ruler indicia and the present invention can be generally called as a measuring device.

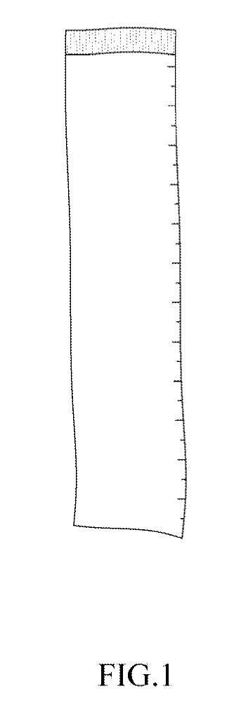

In one aspect of the present invention, a belt is provided with size ruler indicia so that a user can use it to measure the circumference of his/her waist. Referring now to FIG. 1, the contemplated belt has a length and a width. On the border of its length is the size ruler indicia displayed across the longitudinal axis of the length. Preferably the size ruler indicia is disposed along the entire length. Other embodiments can have the size ruler indicia dispose only on a portion of the length.

The contemplated belt has a front side and a back side. In FIG. 1, the size ruler indicia is only shown on the front side of the belt and not on the back side of the belt. In this embodiment, it is only shown on one of the two edges along the length of the front side. Other preferred embodiments can have the size ruler indicia on both edges along the length of the front side, and still further embodiment can have the size ruler indicia on the back side of the belt as well.

In one embodiment, the front side and the back side of the belt can have different colors from each other to ease the reading of the measurements on the size ruler indicia. The two different colors on the front side and the back side of the belt may have great contrasts; for example, one color being black and another color being white. The difference in colors makes it easier for the user to read the measurements.

The contemplated belt is also used to measure the circumference of a user's arm or thigh.

The size ruler indicia can be in metric system or in English system. Preferred embodiments have both.

Preferred embodiment has a total length sufficiently long to wrap around the waist, arm or thigh of a person. Contemplated embodiment can be manufactured in different sizes. For example, waist belts are manufactured in small, medium, large, and X-large, each having a different length to fit a user's waist, arm or thigh size.

Preferred embodiment has a width sufficiently wide to compromise a user's body type. Contemplated embodiment can be manufactured accordingly to the user's needs; there is no limit to the width of the belt.

The contemplated belt can use various thicknesses to compromise a user's need. Different thicknesses can be designed as the user desires to use the contemplated belt for measurements, supports, comfortableness, or any other purposes; there is no limit to the thickness of the belt.

The contemplated belt can use various different known connectors to detachably connect the two terminal ends together. Contemplated belt can use, but not limited to, hook-and-loop connector (i.e., Velcro®), buckle, laces, straps and tapes. The two terminal ends of the contemplate belt can also be joined by a set of zippers. One skilled in the art would immediately recognize various other known connectors that can be used. Preferably the connector is disposed at least one terminal end of the belt. In FIG. 1, a Velcro® strip is shown to dispose at one end of the belt.

The contemplated belt can be made of suitable materials of sufficient strength. Such materials include natural and synthetic polymers, naturally occurring materials, textile fibers, and all reasonable combinations thereof. Preferred embodiment uses neoprene, or a blend of neoprene and butyl rubber. Other embodiments can use sponge rubber.

The contemplated belt can have various surface finishings as desired by a user. Various patterns and decorative designs can also be contemplated.

It should be noted that contemplated belt can have some degree of stretchability, so that the belt may better accommodate the body curvature of an individual, but does not affect the accuracy of the ruler indicia. In another embodiment, the stretchability does not substantially affect the accuracy of the size ruler indicia. Other preferred embodiments can have no stretchability so the size ruler indicia is fixed and not stretched.

In further aspect of the present invention, the contemplated embodiments can be utilized so a user can use it to measure his/her waist, arm or thigh size and to determine the progress of an exercise routine.

In further aspect of the present invention, the contemplated embodiments can be used for back support.

Another aspect of the present invention is a method for measuring exercise progress, this method including steps of:
using the measuring device from any of the above-described embodiments,
wrapping the measuring device around a user's waist, arm or thigh;
recording measurements as indicated by the size ruler indicia;
repeating the measurements throughout a course of exercising period to obtain a series of measuring data; and
comparing the data to determine the exercise progress.

In the contemplated method for measuring exercise progress, the front side and the back side of the belt can have different colors from each other that make it easier for the user to read the measurements on the size ruler indicia. The two different colors on the front side and the back side of the belt may have great contrasts; for example, one color being black and another color being white. The difference in colors provides more precise measurement readings and reports more accurate exercise progress.

What is claimed is:

1. A measuring device comprising:
a front side;
a back side;
a first edge along a length across a longitudinal axis of the measuring device;
a second edge along the length across the longitudinal axis of the measuring device;
a size ruler indicia; and
two terminal ends,
wherein the size ruler indicia is displayed on the front side, on the back side, or on both the front and the back side of the measuring device,
wherein the size ruler indicia is displayed on the first edge, on the second edge, or on both the first and the second edge of the measuring device.

2. The measuring device as claimed in claim 1, wherein the two terminal ends are detachably connected by a hook-and-loop connector (Velcro®), buckle, laces, straps, tapes or zippers.

3. The measuring device as claimed in claim 1 is made of a suitable material including natural polymers, synthetic polymers, naturally occurring materials or textile fibers.

4. The measuring device as claimed in claim 3, wherein the suitable material further includes neoprene or a blend of neoprene and butyl rubber.

5. The measuring device as claimed in claim 3, wherein the suitable material further includes sponge rubber.

6. The measuring device as claimed in claim 3, wherein the suitable material is elastic to accommodate users' body curvatures.

7. The measuring device as claimed in claim 1, wherein the size ruler indicia is in metric system or in English system.

8. The measuring device as claimed in claim 1, wherein the front side and the back side have different colors from each other.

9. The measuring device as claimed in claim 1, wherein the measuring device is sized to measure circumferences of users' waists, arms and thighs.

10. A method for measuring exercise progress, comprising the steps of:
obtaining a measuring device having
a front side;
a back side;
a first edge along a length across a longitudinal axis of the measuring device;
a second edge along the length across the longitudinal axis of the measuring device;
a size ruler indicia; and
two terminal ends,
wherein the size ruler indicia is displayed on the front side, on the back side, or on both the front and the back side of the measuring device,
wherein the size ruler indicia is displayed on the first edge, on the second edge, or on both the first and the second edge of the measuring device;
wrapping the measuring device around a user's waist, arm or thigh;
recording measurements as indicated by the size ruler indicia;
repeating the measurements throughout a course of exercising period to obtain a series of measuring data; and
comparing the data to determine the exercise progress.

11. The method for measuring exercise progress as claimed in claim 10, wherein the size ruler indicia of the measuring device is in metric system or in English system.

12. The method for measuring exercise progress as claimed in claim 10, wherein the measuring device is made of a suitable material including natural polymers, synthetic polymers, naturally occurring materials or textile fibers.

13. The method for measuring exercise progress as claimed in claim 12, wherein the suitable material further includes neoprene or a blend of neoprene and butyl rubber.

14. The method for measuring exercise progress as claimed in claim 12, wherein the suitable material further includes sponge rubber.

15. The method for measuring exercise progress as claimed in claim 12, wherein the suitable material is elastic to accommodate users' body curvatures.

16. The method for measuring exercise progress as claimed in claim 10, wherein the front side and the back side of the measuring device have different colors from each other.

17. The method for measuring exercise progress as claimed in claim 10 further comprising a step of connecting the two terminal ends to fasten the measuring device on the user's waist, arm or thigh.

18. The method for measuring exercise progress as claimed in claim 17, wherein the two terminal ends of the measuring device are detachably connected by a hook-and-loop connector (Velcro®), buckle, laces, straps, tapes or zippers.
